(19) United States
(12) Patent Application Publication
(10) Pub. No.: US 2004/0201681 A1
(43) Pub. Date: Oct. 14, 2004

(54) Multimedia data file producer combining image and sound information together in data file

(76) Inventors: Jack Chen, Hsinchu (TW); Jewel Tsai, Hsinchu (TW); Te-Chih Chang, Hsinchu (TW)

Correspondence Address: LOWE HAUPTMAN GOPSTEIN GILMAN & BERNER, LLP, Suite 310, 1700 Diagonal Road, Alexandria, VA, 22314, US

(21) Appl. No.: 09/884,925

(22) Filed: Jun. 21, 2001

(51) Int. Cl. H04N 5/225

(52) U.S. Cl. 348/207.1

(57) ABSTRACT

A multimedia data file producer for use with a personal computer is disclosed. The multimedia data file producer includes an image pickup device for obtaining desired image information, and a sound pickup device for obtaining desired sound or voice information. The resulting analog signals representing the image and sound information are converted into digital signals and then produced into a multimedia data file incorporated therein the image and sound information. The multimedia data file can be provided for a personal computer connected to the multimedia data file producer for further processing.

### FIELD OF THE INVENTION

The present invention relates to a multimedia data file producer, and more particularly to a multimedia data file producer which produces a multimedia data file provided for a personal computer.

### BACKGROUND OF THE INVENTION

With the rapid development of information industry, the applications of video-audio multimedia information become various. Therefore, the combination of audio and video information together in a data file is a trend in the near future.

### SUMMARY OF THE INVENTION

Therefore, an object of the present invention is to provide a multimedia data file producer for producing a data file including both of image and sound information, which can be easily constructed on the basis of an existent structure.

A first aspect of the present invention relates to a multimedia data file producer adapted to be used with a personal computer. The multimedia data file producer includes an image pickup device for receiving an image signal from an object and transformed the image signal into a first analog signal of a first electric level; a sound image pickup device for receiving a sound signal and transformed the sound signal into a second analog signal of a second electric level; an analog-digital converter electrically connected to the image pickup device and the sound pickup device for converting the first and second analog signals into a first and a second digital signals; and a processor electrically connected to the analog-digital converter for receiving the first and second digital signals to produce a multimedia data file consisting of digital image and sound information, which is provided for the personal computer.

In an embodiment, the image pickup device includes a lens set for focusing the image signal; and a photo-electric converting element for sensing the focused image signal to generate the first analog signal. For example, the photo-electric converting element is a charge coupled device (CCD) or contact image sensor (CIS).

Preferably, the image pickup device further includes a reflection mirror set for transmitting the image signal to the lens set.

In an embodiment, the sound image pickup device includes a microphone for receiving the sound signal and transformed the sound signal into the second analog signal, and a filter for filtering off a noise signal from the second analog signal.

Generally, the noise signal has a frequency beyond a predetermined frequency range. For example, the predetermined frequency range includes a frequency range of a human voice.

Preferably, the multimedia data file producer further includes a multiplexer electrically connected among the image pickup device, the sound pickup device and the analog-digital converter for multitasking the first and second analog signals, and then transmitting the first and second analog signals to the analog-digital converter.

Preferably, the multiplexer performs time-sharing multitasking.

In an embodiment, the sound signal is an aside to be attached to the image of the object. Alternatively, the sound signal is a voice control signal for starting to produce the multimedia data file. The voice control signal is received and transformed into a third analog signal of a third electric level in the sound pickup device, converted into a digital signal in the analog-digital converter, and identified by the personal computer.

According to a second aspect of the present invention, a multimedia data file producer includes an image pickup device for receiving an image signal from an object and transformed the image signal into a first analog signal of a first electric level; a sound image pickup device for receiving a sound signal and transformed the sound signal into a second analog signal of a second electric level; a first analog-digital converter electrically connected to the image pickup device for converting the first analog signal into a first digital signal; a second analog-digital converter electrically connected to the sound pickup device for converting the second analog signal into a second digital signal; and a processor electrically connected to the first and second analog-digital converters for receiving the first and second digital signals to produce a multimedia data file consisting of digital image and sound information, which is provided for the personal computer.

### BRIEF DESCRIPTION OF THE DRAWINGS

The present invention may best be understood through the following description with reference to the accompanying drawings, in which:

FIG. 1 is a schematic block diagram showing a first preferred embodiment of a multimedia data file producer according to the present invention;

FIG. 2 is a schematic block diagram showing a second preferred embodiment of a multimedia data file producer according to the present invention; and

FIG. 3 is a flow chart illustrating an a multimedia data file producer according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

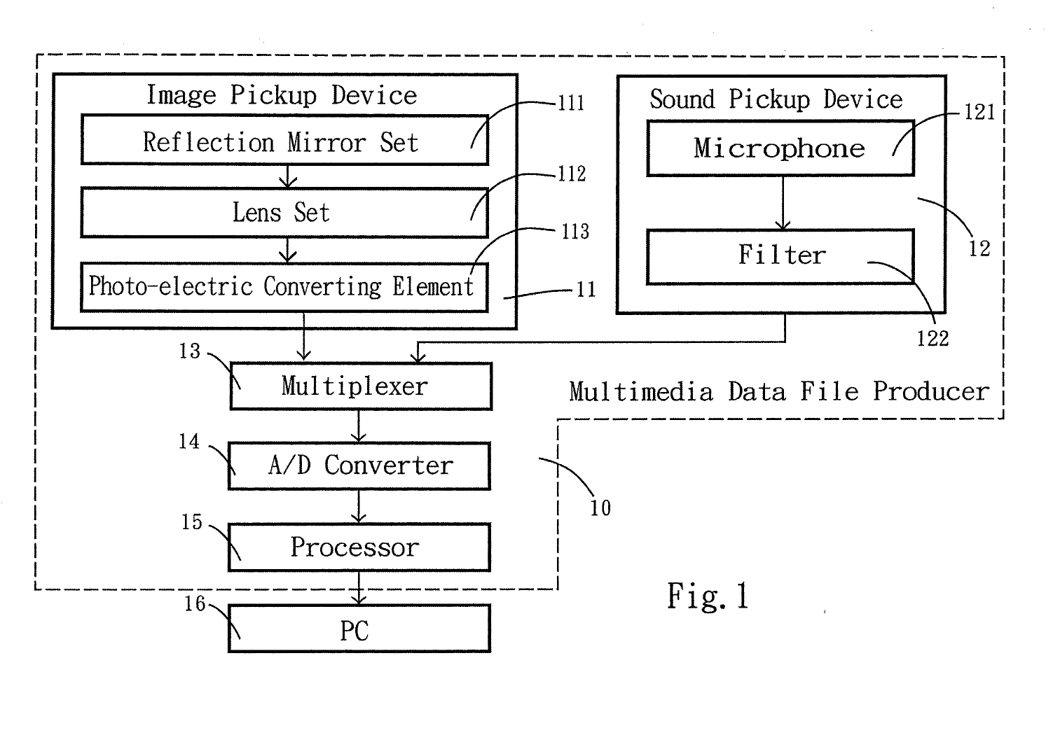

Please refer to FIG. 1 which is a schematic block diagram showing a first preferred embodiment of a multimedia data file producer according to the present invention. The multimedia data file producer includes a housing 10 accommodated therein an image pickup device 11, a sound pickup device 12, a multiplexer 13, a analog-digital (A/D) converter 14, and a processor 15. The image pickup device 11 includes a reflection mirror set 111, a lens set 112 and a photo-electric converting element 113. An optical image signal reflected from an object (not shown) is transmitted to the lens set 112 via the reflection mirror set 111 to be reduced and focused on the photo-electric converting element 113, thereby obtaining an analog signal of a first electric level. The sound pickup device 12 includes a microphone 121 for receiving a sound signal to obtain an analog signal of a second electric level, and a filter 122 for filtering off noise that has frequency beyond the range of human voice from the analog signal of the second electric level. The analog signals of the first and second electric levels are transmitted to A/D converter 14 via the multiplexer 13 in a manner of time-sharing multitasking to be converted into a first and second digital signals. The first and second digital signals are then transmitted to the processor 15 to be produced into a data file incorporating therein both image and sound information. The data file can be transmitted to a personal computer 16 for further processing.

In a preferred embodiment, an existent hardware structure of a digital image scanner is used as the image pickup device 11. In this case, the photo-electric converting element is typically a charge coupled device (CCD) or a contact image sensor (CIS). While a user is operating the digital image scanner to pick up an image of an object, a voice can be added by the sound pickup device 12. For example, when a picture is scanned to produce an electronic picture file, aside can be added from the microphone 121 to tell the story of the picture. After the voice signal is filtered by the filter 122, it is combined with the electronic picture file in the following devices 13, 14 and 15 to produce a multimedia data file which presents the story vividly, compared to only seeing the picture or only listening to the story.

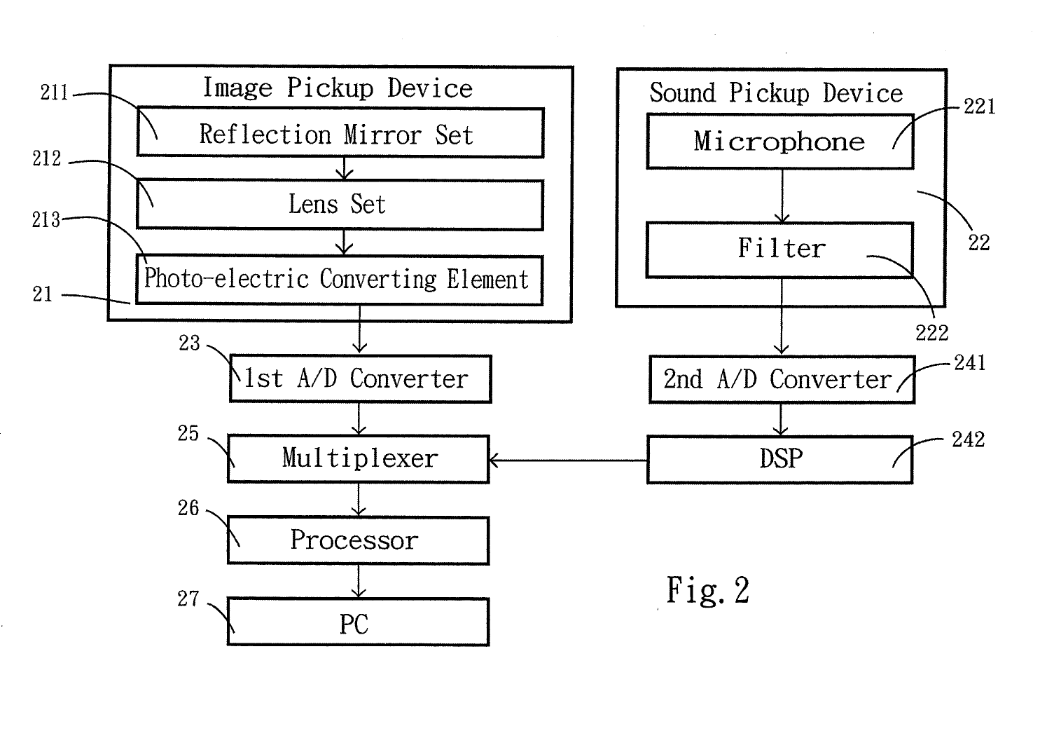

Please refer to FIG. 2 which is a schematic block diagram showing a second preferred embodiment of a multimedia data file producer according to the present invention. Similar to the first embodiment of the multimedia data file producer with reference to FIG. 1, the present multimedia data file producer also includes an image pickup device 21 consisting of a reflection mirror set 211, a lens set 212 and a photo-electric converting element 213 for obtaining the analog signal of the first electric level, and a sound pickup device 22 consisting of a microphone 221 and a filter 222 for obtaining the analog signal of the second electric level and a screened frequency range. Likewise, an existent structure of digital image scanner may be used as the image pickup device 21. The analog signals in this embodiment, however, are converted into digital signals before they enter the following processing. The analog signal of the first electric level is converted into a first digital signal in a first A/D converter 23 connected to the image pickup device 21. The analog signal of the second electric level is converted to a second digital signal in a second A/D converter 241 connected to the sound pickup device 22, and further transmitted to a digital signal processor (DSP) 242 to be processed. The first and second digital signals are then transmitted to a processor 26 via a multiplexer 25 in a manner of time-sharing multitasking to be produced as a multimedia data file incorporating therein the inputted image and sound information which can be provided for a downstream personal computer 27. Alternatively, it is possible to have the function of the DPS 242 performed in the processor 26.

On the basis of the hardware structure of the present invention, the multimedia data file producer can have various applications. For example, the sound pickup device can be used as a voice control device to give a command to the multimedia data file producer. A voice of a designated pattern is received by the microphone and converted into an analog signal of a third electric level in the sound pickup device, and the filter filters off noise that has frequency beyond the range of human voice from the analog signal of the third electric level so as to prevent from mal-action. The analog signal of the third electric level is converted into a digital signal and transmitted to the PC to be identified.

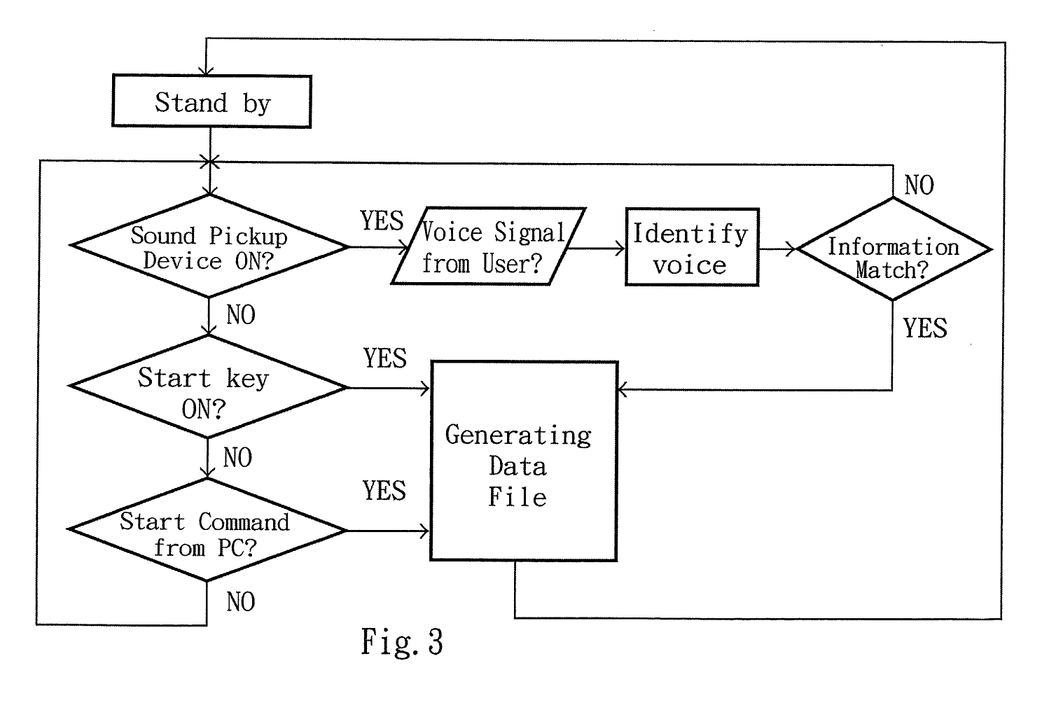

Please refer to FIG. 3 which is a flow chart illustrating an application example of the present multimedia data file producer. When the multimedia data file producer is in a stand-by state, three options are provided for starting the operation of the multimedia data file producer. If the sound pickup device is in an ON state, and receives a voice signal from a user, the voice signal is identified and determined whether to match predetermined data. If positive, the multimedia data file producer will start to perform the data file production operation. This is so-called as voice control. Alternatively, a user can start the multimedia data file producer by conventionally pressing a start key arranged on the housing of the multimedia data file producer or giving a command from the personal computer connected to the multimedia data file producer via an input interface such as a mouse or a keyboard device.

It is advantageous that the multimedia data file producer according to the present invention can be constructed on the basis of an existent hardware structure such as a digital image scanner or a digital camera to integrate image and sound information into a multimedia data file.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multimedia data file producer adapted to be used with a personal computer, comprising:
an image pickup device for receiving an image signal from an object and transformed said image signal into a first analog signal of a first electric level;
a sound image pickup device for receiving a sound signal and transformed said sound signal into a second analog signal of a second electric level;
an analog-digital converter electrically connected to said image pickup device and said sound pickup device for converting said first and second analog signals into a first and a second digital signals; and
a processor electrically connected to said analog-digital converter for receiving said first and second digital signals to produce a multimedia data file consisting of digital image and sound information, which is provided for said personal computer.

2. The multimedia data file producer according to claim 1 wherein said image pickup device includes:
a lens set for focusing said image signal; and
a photo-electric converting element for sensing said focused image signal to generate said first analog signal.

3. The multimedia data file producer according to claim 2 wherein said photo-electric converting element is a charge coupled device (CCD).

4. The multimedia data file producer according to claim 2 wherein said photo-electric converting element is a contact image sensor (CIS).

5. The multimedia data file producer according to claim 2 wherein said image pickup device further includes a reflection mirror set for transmitting said image signal to said lens set.

6. The multimedia data file producer according to claim 1 wherein said sound image pickup device includes a microphone for receiving said sound signal and transformed said sound signal into said second analog signal.

7. The multimedia data file producer according to claim 1 wherein said sound image pickup device includes a filter for filtering off a noise signal from said second analog signal.

8. The multimedia data file producer according to claim 7 wherein said noise signal has a frequency beyond a predetermined frequency range.

9. The multimedia data file producer according to claim 8 wherein said predetermined frequency range includes a frequency range of a human voice.

10. The multimedia data file producer according to claim 1 further comprising a multiplexer electrically connected among said image pickup device, said sound pickup device and said analog-digital converter for multitasking said first and second analog signals, and then transmitting said first and second analog signals to said analog-digital converter.

11. The multimedia data file producer according to claim 10 wherein said multiplexer performs time-sharing multitasking.

12. The multimedia data file producer according to claim 1 wherein said sound signal is an aside to be attached to the image of said object.

13. The multimedia data file producer according to claim 1 wherein said sound signal is a voice control signal for starting to produce said multimedia data file.

14. The multimedia data file producer according to claim 13 wherein said voice control signal is received and transformed into a third analog signal of a third electric level in said sound pickup device, converted into a digital signal in said analog-digital converter, and identified by said personal computer.

15. A multimedia data file producer adapted to be used with a personal computer, comprising:
an image pickup device for receiving an image signal from an object and transformed said image signal into a first analog signal of a first electric level;
a sound image pickup device for receiving a sound signal and transformed said sound signal into a second analog signal of a second electric level;
a first analog-digital converter electrically connected to said image pickup device for converting said first analog signal into a first digital signal;
a second analog-digital converter electrically connected to said sound pickup device for converting said second analog signal into a second digital signal; and
a processor electrically connected to said first and second analog-digital converters for receiving said first and second digital signals to produce a multimedia data file consisting of digital image and sound information, which is provided for said personal computer.

16. The multimedia data file producer according to claim 15 wherein said image pickup device includes:
a lens set for focusing said image signal; and
a photo-electric converting element for sensing said focused image signal to generate said first analog signgngngngngngnal.

17. *p+11Xmultimedia data file producer according to claim 16 wherein said photo-electric converting element is a charge coupled device (CCD).

18. The multimedia data file producer according to claim 16 wherein said photo-electric converting element is a contact image sensor (CIS).

19. The multimedia data file producer according to claim 16 wherein said image pickup device further includes a reflection mirror set for transmitting said image signal to said lens set.

20. The multimedia data file producer according to claim 15 wherein said sound image pickup device includes:
a microphone for receiving said sound signal and transformed said sound signal into said second analog signal; and
a filter for filtering off a noise signal from said second analog signal.

21. The multimedia data file producer according to claim 20 wherein said noise signal has a frequency beyond a frequency range of a human voice.

22. The multimedia data file producer according to claim 15 further comprising a digital signal processor (DSP) which is electrically connected to said second analog-digital converter for receiving and processing said second digital signal, and then outputting said processed second digital signal.

23. The multimedia data file producer according to claim 15 further comprising a multiplexer electrically connected among said first and second analog-digital converters and said processor for multitasking said first and second digital signals, and then transmitting said first and second analog signals to said analog-digital converter.

24. The multimedia data file producer according to claim 23 wherein said multiplexer performs time-sharing multitasking.

25. The multimedia data file producer according to claim 15 wherein said sound signal is an aside to be attached to the image of said object.

26. The multimedia data file producer according to claim 15 wherein said sound signal is a voice control signal for starting to produce said multimedia data file.

27. The multimedia data file producer according to claim 26 wherein said voice control signal is received and transformed into a third analog signal of a third electric level in said sound pickup device, converted into a digital signal in said second analog-digital converter, and identified by said personal computer.
